(19) United States
(12) Patent Application Publication
(10) Pub. No.: US 2014/0347291 A1
(43) Pub. Date: Nov. 27, 2014

(54) TOUCH PANEL APPARATUS AND METHOD OF CONTROLLING THE SAME

(71) Applicant: FUJITSU LIMITED, Kawasaki-shi (JP)

(72) Inventor: Yoshihisa KATSUBE, Kawasaki (JP)

(73) Assignee: FUJITSU LIMITED, Kawasaki-shi (JP)

(21) Appl. No.: 14/254,170

(22) Filed: Apr. 16, 2014

(30) Foreign Application Priority Data
May 24, 2013 (JP) 2013-110320

(51) Int. Cl. G06F 3/041

(52) U.S. Cl. CPC G06F 3/0416; G06F 3/0412
USPC 345/173

(57) ABSTRACT

A touch panel apparatus including a screen including a touch panel function, a hardware key, a detection unit to detect that a foreign object is adhered to a surface of the screen, a function allocation unit to allocate a function of a button displayed on the screen for an interrupt event to the hardware key and disable the button when the detection unit detects that the foreign object is adhered to the surface of the screen, and a notification unit to notify that the function of the button is allocated to the hardware key.

### CROSS-REFERENCE TO RELATED APPLICATION

This application is based upon and claims the benefit of priority of the prior Japanese Patent Application No. 2013-110320, filed on May 24, 2013, the entire contents of which are incorporated herein by reference.

### FIELD

The embodiments described herein are related to a touch panel apparatus, a method of controlling a touch panel apparatus and a non-transitory recording medium storing a program for controlling a touch panel apparatus.

### BACKGROUND

Nowadays, portable electronic devices such as smart phones, which are equipped with touch panel displays, become popular. When a user touches an intended position on the touch panel display with the user's finger or moves the finger in a predetermined order on the touch panel display, the electronic device detects the touch position or the finger's movements. And the electronic device performs a variety of processes according to the detected touch position or the detected finger's movements.

One of the methods of operating the touch panel is called electrostatic capacitance method, by which an electric field is provided on the whole surface of the display and a position touched by a finger etc. is detected by a variation of the surface electric charge. And another method of operating the touch panel is called ultrasonic surface elastic wave method, by which the touch position is detected on the basis of the attenuation of the ultrasonic surface elastic wave. Other methods includes an infrared scanning method, by which grids of infrared light are formed on the display using light emitting elements such as LEDs and light receiving elements such as phototransistors to detect the touch position according to the position at which the infrared light is blocked.

However, when the above methods employed, a water droplet and dust adhered to the surface of the display can be detected as a touch position. Therefore, the positions at which these objects are adhered to the display can be accidentally detected as the touch positions. Thus, a variety of countermeasures are proposed to prevent such accidental detections.

For example, a configuration is disclosed that a space is provided between the substrates forming a touch panel display in Patent Document 1. In the configuration disclosed in the Patent Document 1, surface elastic waves propagate on the internal surfaces of the substrates to prevent the false detections when a water droplet etc. is adhered to the display.

In addition, a configuration for preventing the improper operations of a portable terminal with a touch panel liquid crystal display on board when water droplets are adhered to the liquid crystal display. A water droplet sensor and a proximity sensor etc. are employed in the liquid crystal display device. Further, when these sensors detect a predetermined amount of water droplets, a plurality of sensors such as the proximity sensor etc. are combined to detect the movements of the user's finger and control the display operations.

### PATENT DOCUMENT

[Patent document 1] Japanese Laid-Open Patent Publication No. 2006-343918

[Patent document 2] Japanese Laid-Open Patent Publication No. 2012-238152

### SUMMARY

According to an aspect of the embodiments, it is provided a touch panel apparatus including a screen including a touch panel function, a hardware key, a detection unit to detect that a foreign object is adhered to a surface of the screen, a function allocation unit to allocate a function of a button displayed on the screen for an interrupt event to the hardware key and disable the button when the detection unit detects that the foreign object is adhered to the surface of the screen, and a notification unit to notify that the function of the button is allocated to the hardware key.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating a hardware configuration of a mobile phone terminal according to an embodiment;

FIG. 2 is a functional diagram illustrating functional units in the mobile phone terminal according to the embodiment;

FIG. 3A is a diagram schematically illustrating a structure of a touch panel according to the embodiment;

FIG. 3B is a diagram schematically illustrating a structure of a touch panel according to a variation; and

FIG. 4 is a diagram illustrating a flowchart of processes performed in the mobile phone terminal according to the embodiment.

### DESCRIPTION OF EMBODIMENTS

In the techniques discloses in the above documents, a user handles the display to which water droplets etc. adhere or an additional component such as a proximity sensor is provided for the device in additional the water droplet sensor. Thus, it is one aspect of the technique disclosed herein to provide a touch panel apparatus and a method of controlling a touch panel apparatus to employ a simple configuration to perform processes which the user requests. First, a touch panel apparatus according to one embodiment is described below with reference to the drawings.

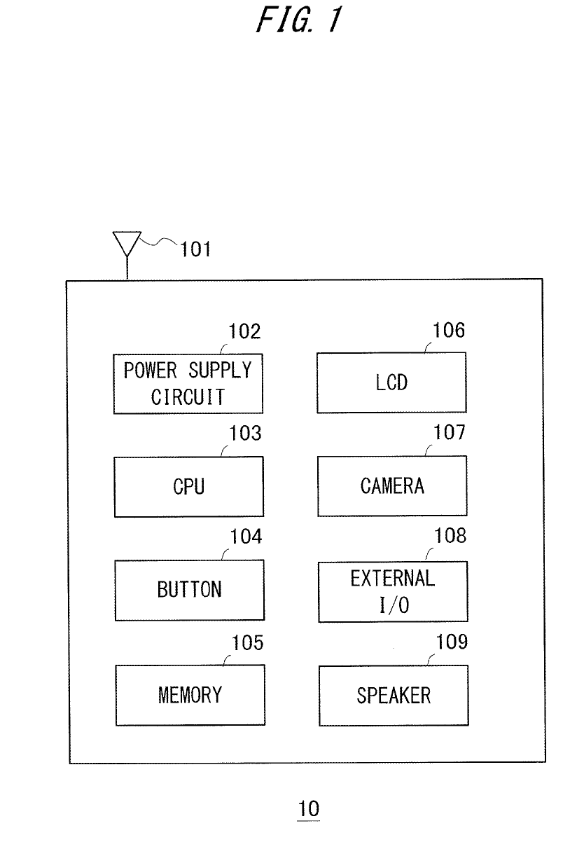

A mobile phone terminal 10 is described as an example of the touch panel apparatus in the present embodiment. As illustrated in FIG. 1, the mobile phone terminal 10 according to the present embodiment includes an antenna 101, a power supply circuit 102, a CPU (Central Processing Unit) 103, a button 104, a memory 105, an LCD (Liquid Crystal Display) 106, a camera device 107, an external I/O (Input/Output) 108 and a speaker 109.

The mobile phone terminal 10 performs wireless communications with external wireless transceivers such as base stations via the antenna 101. The power supply circuit 102 is a circuit for supplying the electric power of a buttery (not illustrated) in the mobile phone terminal 10 for each unit in the mobile phone terminal 10. The CPU 103 is a processor for performing the modulation and demodulation in the wireless communications, processes related to user's operations, a variety of processes related to applications executed in the mobile phone terminal 10. It is noted that a variety of processes performed in the present embodiment can be executed by more than one processor. The button 104 accepts user's operations of the mobile phone terminal 10. The memory 105 is used as a temporary storage area when a variety of processes are performed by the CPU 103. That is, the memory 105 is used as a work area in which a variety of applications and the specific information of the mobile phone terminal such as the terminal number are stored. In addition, the memory 105 stores the settings input by users, the application information, the content data which is provided for the users and the like.

The LCD 106 displays the results of a variety of processes performed by the CPU 103, the processing states, a variety of content and the like. The camera 107 takes pictures according to user instructions. The external I/O 108 is an interface for the mobile phone terminal 10 to connect with external devices. The external I/O 108 includes a variety of communication interfaces including a USB (Universal Serial Bus), a wireless LAN (Local Area Network) including Wi-Fi (Wireless Fidelity) (registered trademark), Bluetooth (registered trademark), and an Infrared output interface, an Infrared receiving unit and the like. The speaker 109 is used when a user makes or receives a call. In addition, the speaker 109 is used for playing music and video, outputting sound for alarm functions, audio notification of incoming calls and the like.

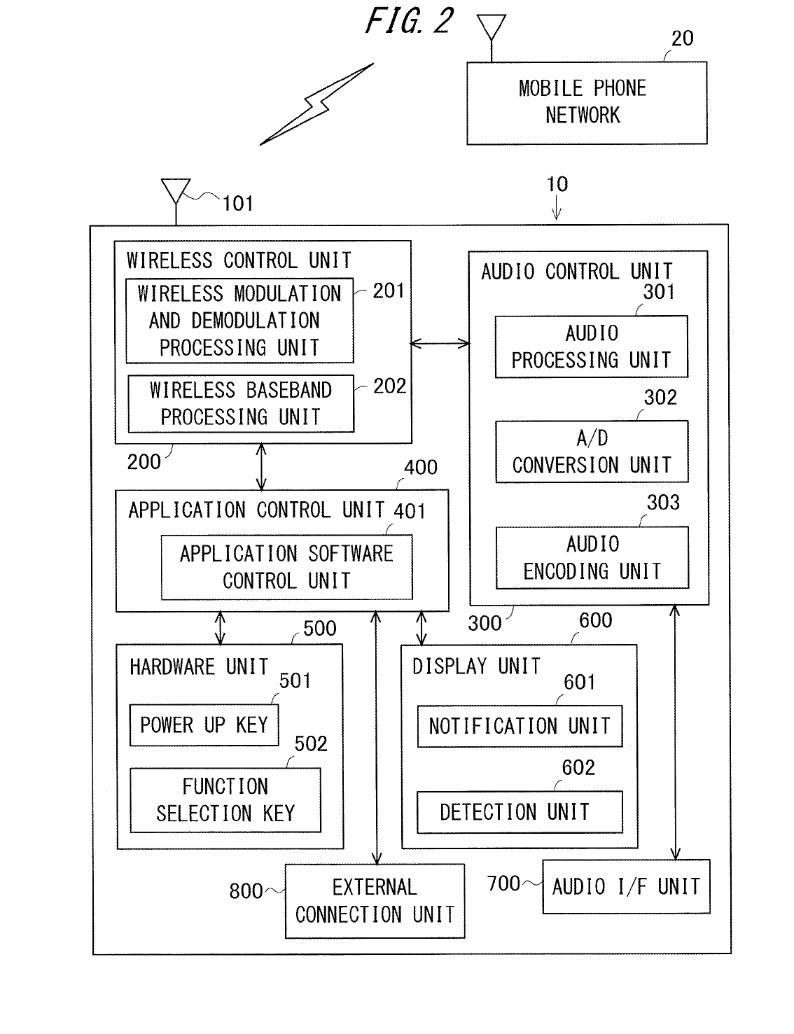

As illustrated in FIG. 2, the mobile phone terminal 10 according to the present embodiment performs wireless communications with the mobile phone network 20, sending and receiving sound, data communications and the like. In addition, applications stored in the memory 105 of the mobile phone terminal 10 are executed by the CPU 103 and the results of the processes are displayed by the LCD 106. With these applications executed, the mobile phone terminal 10 functions as a wireless control unit 200, an audio control unit 300, an application control unit 400, a hardware unit 500, a display unit 600, an audio I/F unit 700 and an external connection unit 800.

Further, the mobile control unit 200 includes functions of a wireless modulation and demodulation processing unit 201 and a wireless baseband processing unit 202. Moreover, the audio control unit 300 includes functions of an audio processing unit 301, an A/D conversion unit 302 and an audio encoding unit 303. The application control unit 400 includes a function of an application software processing unit 401. The hardware unit 500 includes functions of a power up key 501 and a function selection key 502. The display unit 600 includes functions of a notification unit 601 and a detection unit 602.

The wireless control unit 200 performs wireless communications with the mobile phone network 20 via the antenna 101. The wireless modulation and demodulation processing unit 201 modulates information sent to the mobile phone network 20 via the antenna 101 and demodulates signals received from the mobile phone network 20 via the antenna 101. The wireless base band processing unit 202 processes signals according to various communication methods including CDMA (Code Division Multiple Access) and LTE (Long Term Evolution). The information acquired or generated by the wireless control unit 200 is sent to the audio control unit 300, the application control unit 400 and the like.

The audio control unit 300 includes codec functions for encoding and decoding data received from the wireless control unit 200. The audio processing unit 301 performs processes including data compression, data expansion, sampling of the received analog audio signals and quantization thereof. The A/D conversion unit 302 converts analog audio signals to digital audio signals. The audio encoding unit 303 encodes audio according to a variety of encoding schemes such as waveform coding scheme, analysis-synthesis coding scheme and hybrid coding scheme. The audio processing unit 301 sends the audio information obtained after a variety of processes to the wireless control unit 200 and the audio I/F unit 700.

The application control unit 400 executes a variety of applications based on user operations and data received from the wireless control unit 200. The application control unit 400 is an example of the function allocation unit. The application software processing unit 401 uses data received from each unit of the mobile phone terminal 10 to processes the data according to the execution of each application. The hardware unit 500 includes hardware keys etc. for accepting user operations. The power up key 501 is a key for users to power on the mobile phone terminal 10. The function selection key 502 is a key for users to providing instructions for processes performed by a variety of applications after the mobile phone terminal 10 is powered on.

The display unit 600 displays data received from the application control unit 400 via the LCD 106. The notification unit 601 notifies users incoming calls on the LCD 106 when the mobile phone terminal 100 receives incoming call requests. The detection unit 602 detects that a foreign object such as a water droplet is adhered to the LCD 106 as described later. The audio I/F unit 700 uses audio signals received from the audio control unit 300 to perform audio output and sends audio signals input from a microphone (not illustrated) to the audio control unit 300. The external connection unit 800 connects with a variety of external devices to perform input and output of information.

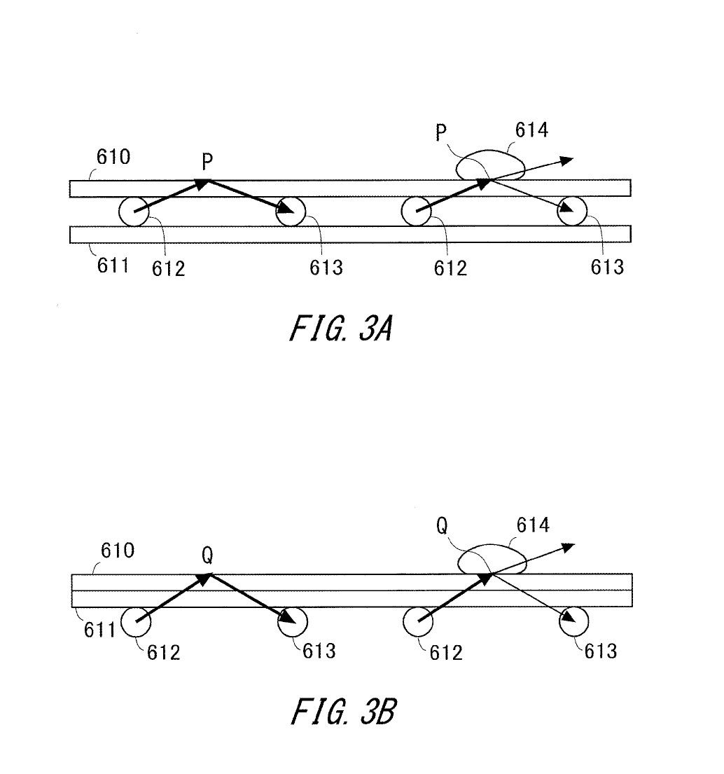

Next, the configurations for detecting that a water droplet is adhered to the display unit 600 are described as an example of the present embodiment with reference to FIGS. 3A and 3B. First, as illustrated in FIG. 3A, the display unit 600 in the present embodiment includes a touch panel 610 with a light transmission property and the LCD 106 including a liquid crystal panel 611. The touch panel 610 includes a touch panel function with which a user selects a button displayed thereon with the user's finger etc. to execute the function corresponding to the selected button. In addition, a light emitting unit 612 and a light receiving unit 613 are provided between the touch panel 610 and the liquid crystal panel 611. The light emitting unit 612 and the light receiving unit 613 function as the detection unit 602. In the present embodiment, the light emitting unit 612 radiates infrared light to the touch panel 610. Further, the light receiving unit 613 receives the infrared light radiated from the light emitting unit 612.

The touch panel 610 is a panel for users to touch for the operations of the mobile phone terminal 10. For example, a user selects the information displayed on the LCD 10 6 by touching the touch panel 610 with a user's finger. FIG. 3A schematically illustrates that the light radiated from the light emitting unit 612 reaches the light receiving unit 613 in a case in which a water droplet 614 is not adhered to the touch panel 610 and in a case in which the water droplet 614 is adhered to the touch panel 610.

When the water droplet 614 is adhered at the position P on the touch panel 610, the infrared light radiated from the light emitting unit 612 propagates to the position P on the upper surface of the touch panel 610, reflects at the position P due to total internal reflection and propagates to the light receiving unit 613. Here, the upper surface of the touch panel 610 is the surface which the user touches with the user's finger etc. As for the total internal reflection of infrared light on the upper surface of the touch panel 610, the critical angle is determined by the index of refraction of the touch panel 610 and the index of refraction of the air on the upper surface of the touch panel 610 on the basis of the Snell's law. Since the system of the total internal reflection is conventionally known, the details thereof are omitted here.

Moreover, when the water droplet 614 is adhered at the position P on the touch panel 610, a part of the infrared light radiated from the light emitting unit 612 reflects at the position P and propagate to the light receiving unit 613. And the remaining part of the infrared light is deflected at the interface between the upper surface of the touch panel 610 and the water droplet 614 and propagates into the water droplet 614. Thus, the amount of infrared light radiated from the light emitting unit 613 and received by the light receiving unit 613 is smaller than that in the case in which the water droplet 614 is adhered at the position P on the touch panel 610. In the present embodiment, a plurality of pairs of the light emitting unit 612 and the light receiving unit 613 are provided for the mobile phone terminal 10. In addition, the application control unit 400 checks the amount of light received by the light receiving unit included in the detection unit 602 and determines that the water droplet 614 is adhered to the touch panel 610 when the amount of infrared light received by the light receiving unit 613 falls below a predetermined threshold.

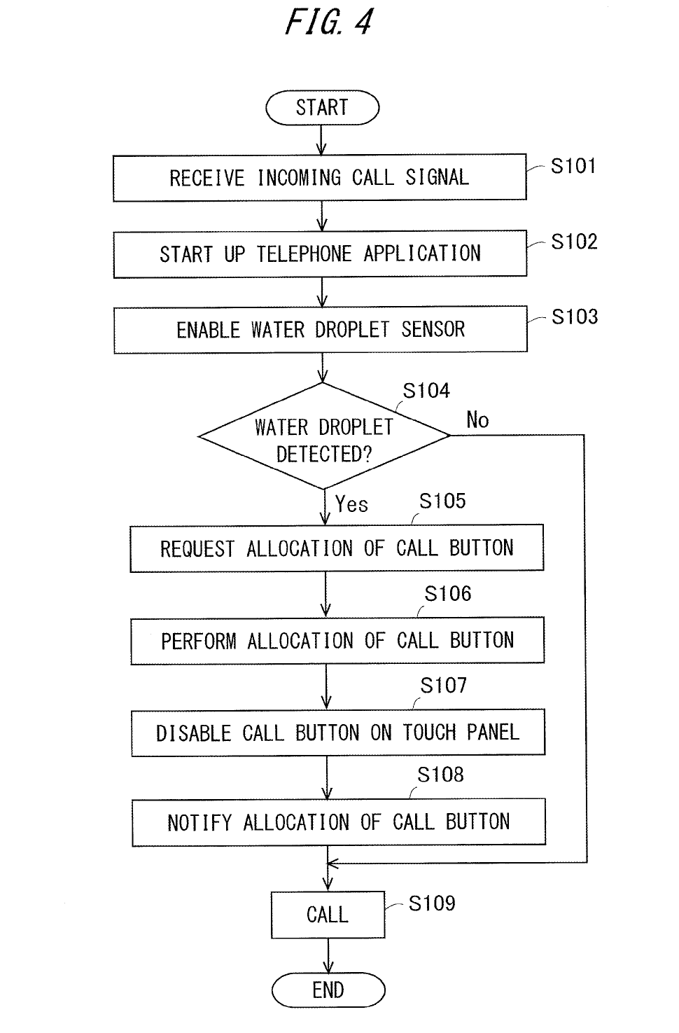

Next, the processes performed when an interrupt event occurs in the mobile phone terminal 100 are described with reference to FIG. 4. In the explanations below, each step is abbreviated by S. In the present embodiment, processes in the flowchart as illustrated in FIG. 4 are initiated when the mobile phone terminal 100 is powered on. In addition, an incoming call event is described as an example of the interrupt event in the mobile phone terminal 100 in the following explanations. Each process in the flowchart in FIG. 4 is performed by the CPU 103.

In S101, the wireless control unit 200 receives an incoming call signal transmitted via the antenna 101 from the mobile phone network 20 to the mobile phone terminal 100. And the process proceeds to S102. In S102, the application control unit 400 controls the application software processing unit 401 to startup a telephone application. In the present embodiment, the telephone application is an application for performing call processes in the mobile phone terminal 100 when the mobile phone terminal 100 receives an incoming call signal from the mobile phone network 20 and when a user uses the mobile phone terminal 100 to transmit an outgoing call signal to the mobile phone network 20. As described above, the telephone application is stored in the memory 105. In the following explanations, each application executed by the application software processing unit 401 is stored in the memory 105. It is noted that an application can be executed independently or a plurality of applications can be executed in parallel. And then the process proceeds to S103.

In S103, the CPU 103 controls the detection unit 602 to enable a water droplet sensor. When the water droplet sensor is enabled, infrared light is radiated from the light emitting unit 612 and received by the light receiving unit 613 as described above. The information of the amount of light received by the light receiving unit 613 is sent to the application control unit 400. In the present embodiment, the application control unit 400 controls the application software processing unit 401 to start up an application for water droplet determination to determine whether or not the amount of light received by the light receiving unit 613 is below a predetermined threshold. And the process proceeds to S104. In S104, the application for water droplet determination determines whether or not the amount of light received by the light receiving unit 613 is below the predetermined threshold. When it is determined that the amount of light received by the light receiving unit 613 is below the predetermined threshold (S104: Yes), it is taken that a water droplet is adhered to the touch panel 610 and the process proceeds to S105. On the other hand, When it is determined that the amount of light received by the light receiving unit 613 is more than or equal to the predetermined threshold (S104: No), it is taken that a water droplet is not adhered to the touch panel 610 and the process proceeds to S109.

In the present embodiment, when the mobile phone terminal 100 receives an incoming call signal, a call button is displayed on the LCD 106 to respond the incoming call and perform the call. The user performs the function of the call button by touch the position at which the call button is displayed on the touch panel 610. Therefore, when a foreign object such as a water droplet is adhered to the touch panel 610, the object is falsely recognized as a user's finger etc. and the function of the call button can be performed without the user operations of touching the call button. In addition, when the user tries to start a call by touching the call button, the call button cannot normally operate because a part other than the part at which the call button is displayed is falsely recognized as a touch position. Thus, the processes from S105 to S108 as described below are performed in the present embodiment. As a result, when a foreign object is adhered to the touch panel 610, the false recognition of the touch panel as described above can be prevented and the function of the call button on the touch panel is disabled.

In S105, the application control unit 400 requests the application software processing unit 401 to allocate the function of the call button displayed on the touch panel 610 to a hardware key included in the hardware unit. Next, the process proceeds to S106. In S106, the application software processing unit 401 executes an application for the allocation of the call button. A hardware key driver is an example of the application for the allocation of the call button. When the application is executed, the function of the call button displayed on the touch panel 610 is allocated to a key of the hardware unit 500. For example, the function of the call button can be allocated to the power up key 501 or a key of the other function selection keys 502. Alternately, the function of the call button can be allocated to a combination of the power up key 501 and the function selection keys 502. It is noted that when the function of the call button is allocated to one key, the user might accidentally operates the key to perform the function. Therefore, when the function is allocated to the combination of the plural keys, the user's accidental operations can be advantageously prevented. When the allocation of the call button is completed, the process proceeds to S107.

In S107, the application software processing unit 401 notifies the telephone application that the allocation of the call button is completed. When the telephone application receives the notification of the completion of the allocation of the call button, the telephone application disables the call button displayed on the touch panel 610. As a result, the function of the call button displayed on the touch panel 610 is disabled and the telephone application does not accept user operations such as touching of the call button. Thus, a foreign object adhered on the touch panel 610 cannot be recognized as a user's finger etc. when the foreign object is located on the call button on the touch panel 610. Next, the process proceeds to S108.

In S108, the telephone application sends a message to the display unit 600 to notify that the call button displayed on the touch panel 610 is disabled and the function of the call button is allocated to the key(s) determined in S106. And the notification unit 601 displays the message received from the telephone application on the display unit 600. Next, the process proceeds to S109. In S109, the telephone application performs call processes according of the user operations specified in S106. Thus, the mobile phone terminal 100 can prevent the false recognition of the touch panel and perform the function of the call button according to the user operations of the hardware keys.

Although the present embodiment is described as above, the configurations and the processes of the information processing apparatus are not limited to those as described above and various variations maybe made to the embodiment described herein within the technical scope of the present invention. For example, in the above embodiment, the mobile phone terminal 10 is an example of the touch panel apparatus. However, the configurations as described above can be applied not only to mobile phone terminals but also to a variety of electric information apparatus such as a tablet PC (Personal Computer) as long as a touch panel device includes a hardware key. In addition, the light emitting unit 612 and the light receiving unit 613 are provided as detection units for detecting the adherence of a foreign object on the touch panel 610 as illustrated in FIG. 3A. However, a configuration as illustrated in FIG. 3B can also be employed. It is noted that since the elements as illustrated in FIG. 3B are similar to the elements as illustrated in FIG. 3A, the same numbers as in FIG. 3A are given to the elements.

In the configuration as illustrated in FIG. 3B, the touch panel 610 and the liquid crystal panel 611 overlap each other. In addition, the light emitting unit 612 and the light receiving unit 613 are provided under the overlapped touch panel 610 and liquid crystal panel 611. Similar to FIG. 3A, when a water droplet is not adhered at the position Q on the touch panel 610, the light radiated from the light emitting unit 612 reflects at the interface between the touch panel 610 and the air due to the total internal reflection and propagates to the light receiving unit 613. Further, when a water droplet is adhered at the position Q on the touch panel 610, when the infrared light radiated from the light emitting unit 612 reaches the position Q, a part of the infrared light reflects at the interface between the touch panel 610 and the air and the remaining infrared light propagates to the light receiving unit 613. As a result, similar to the configurations as illustrated in FIG. 3A, when the water droplet is adhered on the touch panel 610, the amount of light received by the light receiving unit 613 decreases. Since the other configurations of the mobile phone terminal 100 etc. are similar to the configurations in the above embodiment, the detailed descriptions are omitted here.

Moreover, the light emitting unit 612 radiates infrared light and the light receiving unit 613 receives the infrared light in the above embodiment. However, the backlight for the touch panel 610 can be used instead of the light radiated from the light emitting unit 612. Namely, the application control unit 400 can determine whether or not a water droplet etc. is adhered to the touch panel 610 according to the decrease of the amount of backlight received by the light receiving unit 613. Further, the incoming call event is an example of the interrupt events in the above embodiment. However, the configurations of the above embodiment can be applied to other button allocation cases including a check button for incoming emails, an alarm cancel button for alarms set by using a timer, a message confirmation button for irregular messages such as emergency earthquake alert messages. Since the processes performed for the button allocations in the other cases are similar to the button allocation for the incoming call button as described above, the detailed descriptions are omitted here.

<<Computer Readable Recording Medium>>

It is possible to record a program which causes a computer to implement any of the functions described above on a computer readable recording medium. Here, the functions include an allocation of a button function for example. In addition, by causing the computer to read in the program from the recording medium and execute it, the function thereof can be provided. Here, the computer includes mobile phone terminals for example.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

A touch panel apparatus, a method of controlling a touch panel apparatus and a non-transitory recording medium storing a program for controlling a touch panel apparatus according to one embodiment can perform processes according to the user operations in a more reliable manner and with a simpler configuration than the conventional techniques.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A touch panel apparatus, comprising:
a screen including a touch panel function;
a hardware key;
a detection unit to detect that a foreign object is adhered to a surface of the screen;
a function allocation unit to allocate a function of a button displayed on the screen for an interrupt event to the hardware key and disable the button when the detection unit detects that the foreign object is adhered to the surface of the screen; and
a notification unit to notify that the function of the button is allocated to the hardware key.

2. The touch panel apparatus according to claim 1, wherein the hardware key includes a plurality of keys, and the function allocation unit allocates the function of the button to a combination of the plurality of keys.

3. A method of controlling a touch panel apparatus including a screen including a touch panel function and a hardware key, the method comprising:
detecting by a processor that a foreign object is adhered to a surface of the screen;
allocating by the processor a function of a button displayed on the screen for an interrupt event to the hardware key and disable the button when it is detected that the foreign object is adhered to the surface of the screen; and
notifying by the processor that the function of the button is allocated to the hardware key.

4. The method of the touch panel apparatus according to claim 3, wherein
the hardware key includes a plurality of keys, and
the allocating allocates the function of the button to a combination of the plurality of keys.

5. A non-transitory recording medium storing a program that causes a computer to execute a process comprising:
detecting that a foreign object is adhered to a surface of a screen including a touch panel function;
allocating a function of a button displayed on the screen for an interrupt event to a hardware key and disable the button when it is detected that the foreign object is adhered to the surface of the screen; and
notifying that the function of the button is allocated to the hardware key.

6. The non-transitory recording medium according to claim 5, wherein
the hardware key includes a plurality of keys, and
the allocating allocates the function of the button to a combination of the plurality of keys.
